(19) United States
(12) Patent Application Publication
(10) Pub. No.: US 2007/0156591 A1
(43) Pub. Date: Jul. 5, 2007

(54) Program distribution server, method, program, and recording medium

(76) Inventor: Takashi Akutsu, Kawaguchi-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/600,522

(22) Filed: Nov. 15, 2006

(30) Foreign Application Priority Data
Nov. 15, 2005 (JP) 2005-330673

(51) Int. Cl. G06Q 99/00

(52) U.S. Cl. 705/51

(57) ABSTRACT

A program distribution server distributes a plurality of software supplied from an external vender to a user terminal upon request. The program distribution server includes first information that relates to a function included in the software. Second information is included to specify the function of the software. A function is changed in accordance with upgrading of the software. Third information is also included to indicate a correspondence between the software and dependent software installed in the user terminal. The dependent software runs in dependence upon the software. The fourth information is also included to indicate correspondence between the function of the software used by the dependent software and the dependent software itself. The program distribution server determines possibility of updating of software to be distributed to the user terminal based on the first to fourth information.

### CROSS REFERENCE TO RELATED APPLICATION

This application claims priority under 35 USC §119 to Japanese Patent Application No. 2005-330673, filed on Nov. 15, 2005, the entire contents of which are herein incorporated by reference.

### BACKGROUND OF THE INVENTION

1. Field of the Invention

The present invention relates to program distribution servers, program distribution methods, program distribution programs, and such program recording mediums capable of providing a user terminal with program upon request via a network.

2. Discussion of the Background Art

As discussed in Japanese Patent Registration NO. 3,385,590, a system capable of distributing software updated via a computer network such as Internet is described. Specifically, a component (an update-component) is employed in a computer system running with a program, and automatically accesses a server, which distributes the program, and updates the program.

Another program on which the program depends, is simultaneously updated if it exists. Since the program is automatically updated, the burden on a user is reduced. To simultaneously update a plurality of program having dependence safely according to the technology of the Japanese Patent Registration NO. 3,385,590, the dependence must be defined and controlled while maintaining that the information is current.

Prescribed software (hereinafter referred to as platform software) provides an interface called SDK (Software Development Kit) or plug-in.

The platform software is sometimes used as is. However, an external vender uses these interfaces and expands the platform software from time to time. Further, the external vender sometimes uniquely sells the expanded portion (hereinafter referred to as solution software). Solution software generally enters into a market delayed in time after the platform software.

When a countermeasure against trouble is taken or a function is expanded as to the platform software, a vender, as a provider of it, needs to notify an external vender that an updated version of the platform software will be distributed into a market. The notified external vender needs to evaluate and make an announcement to a market as to whether or not the updated version causes a problem when working with solution software already released.

When a number of solution software programs significantly increases, update of the platform software is obstructed. That is, if the update version is released after all of the solution software is evaluated, confirmation labor increases and the updated version cannot be promptly provided. Further, a customer using the platform software alone does not need to evaluate the performance with respect to its cooperation with the solution software, and rather quickly needs an updated version.

However, when a system discussed in the Japanese Patent Registration No. 3,385,590 is employed, controlling the dependence information becomes troublesome, significantly, and the dependence information must be dynamically updated in accordance with either a combination with the adopted solution software or the completion level of a combination evaluation.

In other words, the newly upgraded software should appear to a customer using either the platform software alone or only the solution software given a complete combination evaluation as if an update version is provided. Newly upgraded software should also appear to a customer using the solution software without completely receiving the combined evaluation as if an updated version is not provided.

### SUMMARY OF THE INVENTION

A program distribution server, method, program and recording system are described. In one embodiment, a program distribution server to distribute one of at least two software programs supplied from an external vender to a user terminal upon request, the program distribution server including: first information related to at least two functions included in each of the at least two software programs supplied from the external vender; second information specifying at least one of the at least two functions of the software, the least one of the at least two functions being changed in accordance with upgrading of the at least two software programs; third information indicating correspondence between the at least two software programs and dependent software installed in the user terminal, the dependent software running in dependence upon one of the at least two software programs; and fourth information indicating correspondence between the function of each of the at least two software programs and the dependent software, the function of each of the at least two software programs is used by the dependent software; wherein the program distribution server determines a possibility of updating of software to be distributed to the user terminal based on the first, second, third and fourth information.

### DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates a control information table storing control information, which is employed both in conventional and present invention program distribution servers;

FIG. 2 also illustrates a control information table storing control information, which is included in a conventional program distribution server and an exemplary program distribution server according to one embodiment of the present invention;

FIG. 3 illustrates a control information table storing control information, which is included in a program distribution server according to one embodiment of the present invention;

FIG. 4 illustrates another control information table storing control information, which is included in a program distribution server according to one embodiment of the present invention;

FIG. 5 illustrates still another control information table storing control information related to a test request according to one embodiment of the present invention;

FIG. 6 illustrates a control information table storing control information for controlling test machines according to one embodiment of the present invention;

FIG. 7 illustrates an exemplary inspection test for inspecting the operation of software according to one embodiment of the present invention;

FIG. 8 illustrates still another control information table storing setting information for software according to one embodiment of the present invention;

FIG. 9 illustrates still another exemplary control information table storing control information related to testing result according to one embodiment of the present invention; and

FIG. 10 illustrates an exemplary configuration of a program distribution system including a program distribution server according to one embodiment of the present invention.

### DETAILED DESCRIPTION OF THE PREFERRED EMBODIMENTS

Embodiments of the present invention include a new program distribution server that are described below.

In one embodiment, the program distribution server distributes a plurality of software programs supplied from an external vender to a user terminal upon request. The program distribution server includes first information that relates to a function included in the software. Second information is also included to specify the function of the software. A function is changed in accordance with upgrading of the software. Third information is also included to indicate correspondence between the software and dependent software installed in the user terminal. The depending software runs in dependence upon the software. The fourth information is also included to indicate correspondence between the function of the software used by the dependent software and the dependent software. The program distribution server determines possibility of updating of software to be distributed to the user terminal based on the first to fourth information.

In another embodiment, the program distribution server notifies a developer terminal that an operational inspection for the dependence software is needed and controls a test case execution device to executes a test case via a LAN when the software is upgraded and determines if an operational inspection for dependent software is needed based on the first to fourth information is positive. The test case includes operational inspection for dependence software. The program distribution server determines that the software can be updated when the test case is successful.

In yet another embodiment, an accounting device is provided to execute accounting while keeping security. The program distribution server sends a bill for a testing cost to a test request terminal when the test case is executed.

Referring now to the drawings, wherein like reference numerals and marks designate identical or corresponding parts throughout several figures.

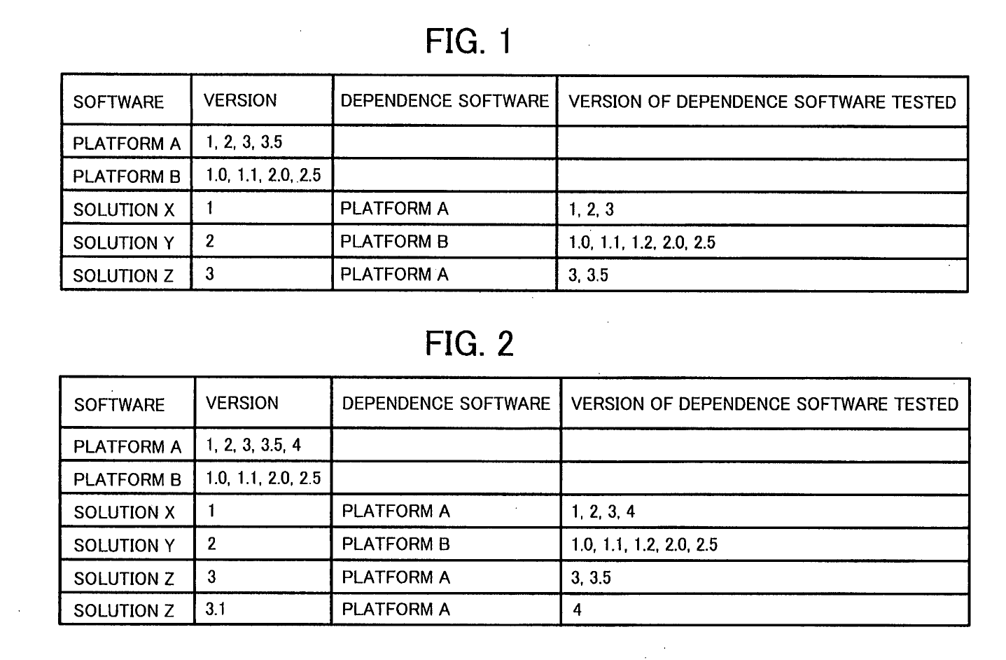

A conventional program distribution server is initially described to compare with that of the present invention with reference to FIGS. 1 and 2. The program distribution server includes control information for controlling the dependence between a plurality of program under control. Data structure of the control information is exemplified in a control information table included in the program distribution server.

Software of platform-A and B in the first and second lines of the table of FIG. 1 do not relate to the other software, and thus, handle features of the entire functions by themselves. The second column indicates versions that are already released. The third and subsequent lines of the table represent software that achieve functions together with the other dependent software.

As shown in FIG. 1, software “Solution-X” is understood that the version 1 thereof has been released (as shown in the second column) and needs “Platform-A” of the third column. Further, it is understood that versions 1 to 3 in the fourth column are given a combination operation inspection. Combinations of the other versions of the Solution-X and Platform-A are not inspected, and thus interoperability is not guaranteed.

Now, an operation of the conventional program distribution server is described. Upon receiving an inquiry about presence of update from a system (e.g. a personal computer) using the version 3 of the Platform-A alone, the conventional program distribution server determines and answers thereto that an updated version of the version 3.5 of the Platform-A is available with reference to information of the first line of FIG. 1.

Upon receiving an inquiry about presence of the update from a system using the version 1 of the Solution-X and the version 2 of Platform-A, the conventional program distribution server determines and answer thereto that the update of the version 3 of the Platform-A is available with reference to information of the third line of FIG. 1.

Although the version 3.5 of the Platform-A is practically prepared with reference to information of the first line of FIG. 1, this is neglected, because evaluation for a combination with the version 1 of the Solution-X is not yet completed.

When the version 4 of the Platform-A is released in this situation, the version 4 is immediately added to the version column on the first line of FIG. 1, and is disclosed to a system using the Platform-A alone. When the version 1 of the Solution-X utilizing the Platform-A is confirmed to be able to operate without any problem with the version 4 of the Platform-A, the version 4 is added into the column of the test completed dependence software version in the third line of FIG. 1.

Further, when the Solution-Z utilizing the Platform-A causes a problem with the version 4 of the Platform-A, and it is changed to the version 3. 1, the sixth line is newly added as shown in FIG. 2. When dependence is updated to a condition as shown in FIG. 2, and an inquiry arrives from a system using the versions 3 of the Solution-Z and the Platform-A, it is answered that the version 3.1 of the Solution-Z and the version 4 of the Platform-A can simultaneously be updated.

As mentioned heretofore, the conventional program distribution server controls dependence between software under control. However, such an update of the dependence of the Solution-X and Solution-Z is manually executed in accordance with a test result, and thereby requires control labor.

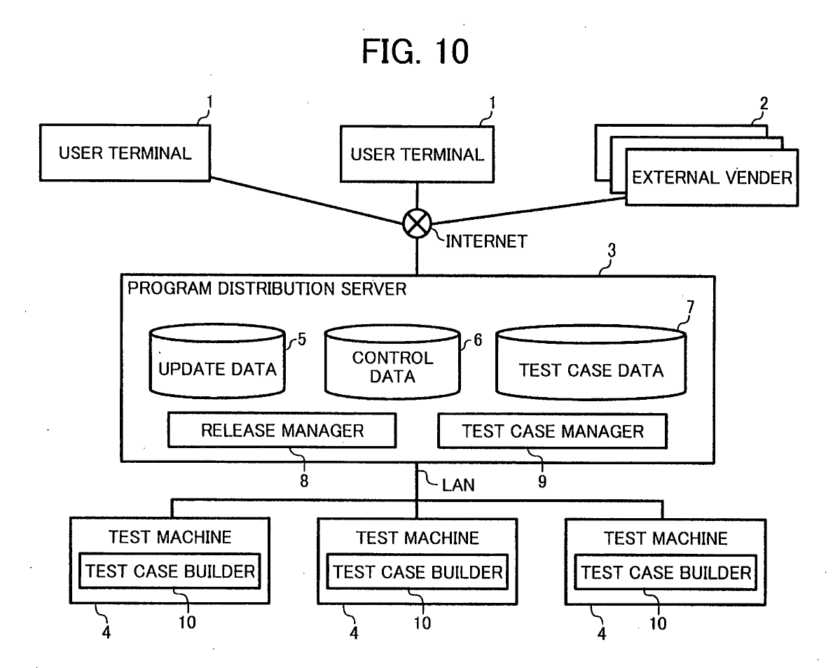

Now, an exemplary structure and function of a program distribution system including a program distribution server according to one embodiment of the present invention is described with reference to FIG. 10.

As shown, such a program distribution system includes a user terminal 1, an external vender 2, a program distribution server 3, and test machines 4. The user terminal 1 and the external vender 2 are connected to the program distribution server 3 via the Internet. The program distribution server 3 is connected to the test machines 4 via the LAN.

The program distribution server 3 includes a plurality of databases 5 to 7, a release manager 8, and a test case manager 9. -Further, each of the test machines 4 includes a test case builder 10.

The database 5 stores update program and data in order to update software. The database 6 stores control data for controlling software under control of the program distribution server 3. The database 7 stores test program and data for inspecting an operation of a software combination.

The release manager 8 works together with an update component (see, the above-mentioned JP registration patent) that works in a user environment of an update requesting origin (i.e., a user terminal 1). Specifically, the release manager 8 receives an update request from the update component of the user terminal 1, and investigates if there exists updatable information using control data (data of FIGS. 1 and 2) included in the database 6.

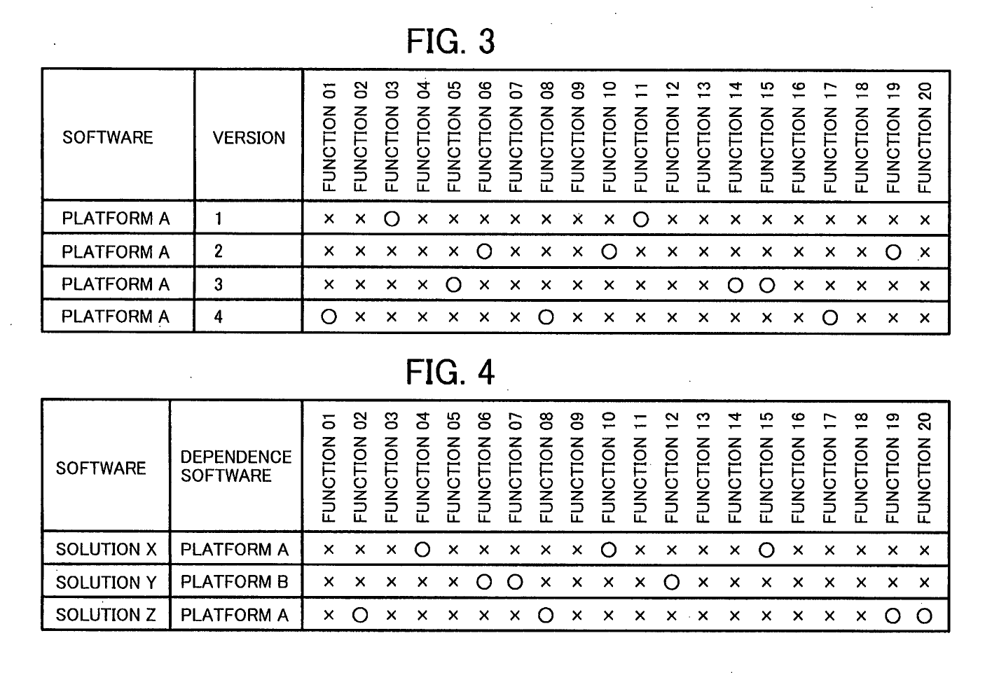

Then, the release manager 8 notifies the update component when the updatable information exists as a response to the request. The release manager 8 also transmits update data to the update component. The release manager 8 receives and stores information of update contents released from the external vender 2 in the databases 5 and 6 as update data and control data as shown in FIGS. 3 and 4.

The release manager 8 also determines whether the test is needed using the control data of FIGS. 3 and 4. When the test is needed, the release manager 8 sends a test request to the test case manager 9 and notifies the external vender thereof.

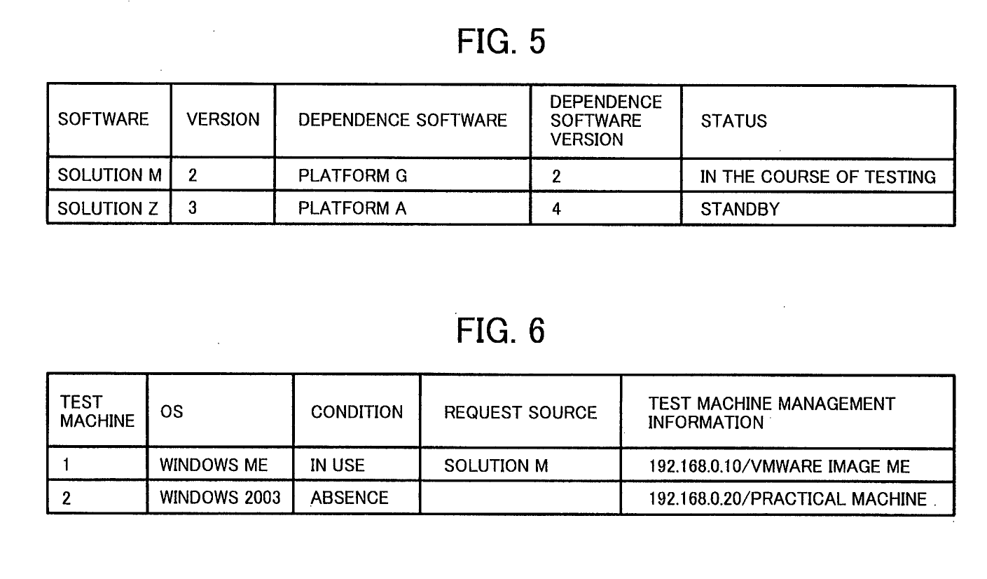

The test case manager 9 executes queuing by inserting the test request sent from the release manager 8 into the control data of FIG. 5 at a prescribed position. When the test requests are pooled, the test case manager 9 searches a test machine from the control data of FIG. 6, and starts the test machine that is found.

Subsequently, test objective program and test case data are transmitted to the test case builder 10. The test case manager 9 receives a test result from the test case builder 10, and either executes a notification or request for updating the control data of FIG. 2 to the release manager 8 in accordance with the test result.

The test case builder 10 is automatically operated when the test machine starts, and establishes communication with the test case manager 9.

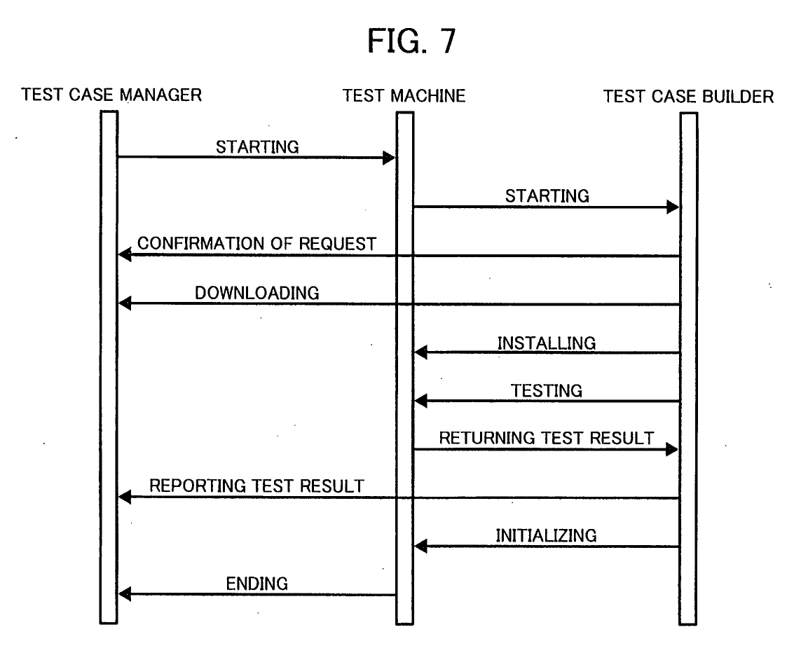

Further, the test case builder 10 downloads test objective program and test case data from the test case manager 9 and executes such testing. The test case builder 10 notifies the test case manager 9 of the test result, and initializes and prepares the test machine for the next test every time the test is completed as shown in FIGS. 7 and 10.

Now, an exemplary operation of the program distribution system including the program distribution server according to one embodiment of the present invention is described with reference to drawings.

The release manager 8 working on the present system divides a function of the Platform-A serving as a dependence destination into an appropriate size, and monitors changes and identifies functions to be affected by the changes when the Platform-A is updated. The function is sometimes represented as “printing a document”, or can be “each of functions” provided by the SKD.

FIG. 3 illustrates an abstract of the information of the Platform-A. As shown, releasing of the version 4 causes a change in functions 01, 08, and 17. Since the amount of labor significantly increases when information of FIG. 3 is manually provided as in the past, the information is preserved in the database 6 of the program distribution server 3 as control information according to one embodiment of the present invention. Information of FIG. 3 serving as control data is generally automatically created by the program distribution server 3 using a functional classification of a file that constitutes software serving as a control objective and presence and absence of updating for the file, wherein circles represent the presence and crisscrosses represent the absence, respectively.

The program distribution server 3 also controls information illustrated in FIG. 4 similar to that of FIG. 3 as control data. The information of FIG. 4 represents functions of depending objective software that dependent software depends upon, wherein circles represent usage of a function and crisscrosses represent a no-usage of a function, respectively. A software developer of the dependent software provides such information.

When the update version 4 of Platform-A is released and information on line 4 of the table of FIG. 3 is fixed, the release manager 8 automatically determines if an update of Platform-A affects Solution-X and Solution-Z with reference to the information of FIG. 4. As understood from FIG. 4, a function used by the Solution-X is not changed, while the update of the function 8 possibly affects the Solution-Z.

Specifically, the release manager 8 immediately and automatically determines that the Solution-X is safe in updating the version 4 of the Platform-A, and updates information related to the Solution-X shown in FIG. 2 in order to immediately causes reflection, thereby executing releasing the Solution-X. The release manager 8 cannot immediately release the Solution-Z, and it is determined that an evaluation of combination with the function 8 is necessitated.

Now, evaluation of Solution-Z, the need of which is confirmed as mentioned above, is described. A release manager 8 notifies a test case manager 9, and the release manager 8 executes queuing of a test request. In one embodiment of the present system, the release manager 8 notifies a manager or a developer of the Solution-Z of presence of a problem in dependence by electronic mail or the like at this point.

Further, according to the present system, a test case provided from a commodity program provider is started together with Solution-Z also as commodity program, thereby a test result is obtained. Such a test case includes test use program or test data for executing the test.

When the Solution-Z succeeds in the test, it is determined that there is no influence, and such a result is immediately reflected to a control information table as shown in FIG. 2. Otherwise, as mentioned above, such a test result is notified to the manager or the developer of the Solution-Z by electronic mail in order to urge him or her to update the Solution-Z.

The above-mentioned test case is realized and performed as mentioned herein below. Specifically, the test case manager 9 operates on a system of the program distribution server 3 and controls a test request transmitted from the release manager 8. Upon receiving a test request, the test manager 9 executes queuing for the test request in a manner as shown in FIG. 5.

As a status, standby, on the way of testing, or test completion is exemplified.

When more than one request is pooled, the test case manager 9 searches a non-use instrument from a control table for controlling the test machine 4 as shown in FIG. 6, and assigns it to the test request. When an assignable test machine 4 is found, the test case manager 9 starts a computer or an environment (e.g. a Virtual PC, a VMWare) that emulates a computer with software. The computer executing the test can obtain power through a network board.

This execution environment is set up to automatically login and to start a test case builder 10 when the operation system starts as illustrated in FIG. 7. After starting up, the test case builder 10 communicates with the test case manager 9 via a network or the like and downloads and installs software necessary for testing.

Further, the test case builder 10 also similarly downloads a test case as evaluation objective software, and starts the test case. When the test case is completed, the test case manager 9 is notified of the result via the test case builder 10. The test case manager 9 executes the above-mentioned mail notification and updating information of FIG. 2 by requesting to the release manager 8 in accordance with the test result.

The test case builder 10 changes a start up parameter of the operation system so that the operation system on a different partition is started, for example, and executes restarting when the test is completed. As a result, the restarted execution environment initializes the previously used test environment to an original initial condition, and executes initialization and shuts down the computer itself so that it can prepare for the next test request.

When an emulator is used, such an environment is simply abandoned and a template environment can be realized only by file copying.

The test case manager 9 repeats the above-mentioned operations until test requests given queuing disappear.

Then, the test case manager 9 stores accounting information consumed during execution of the test case. For example, such information relates to a time period necessitated during the test, a number of test cases executed, etc.

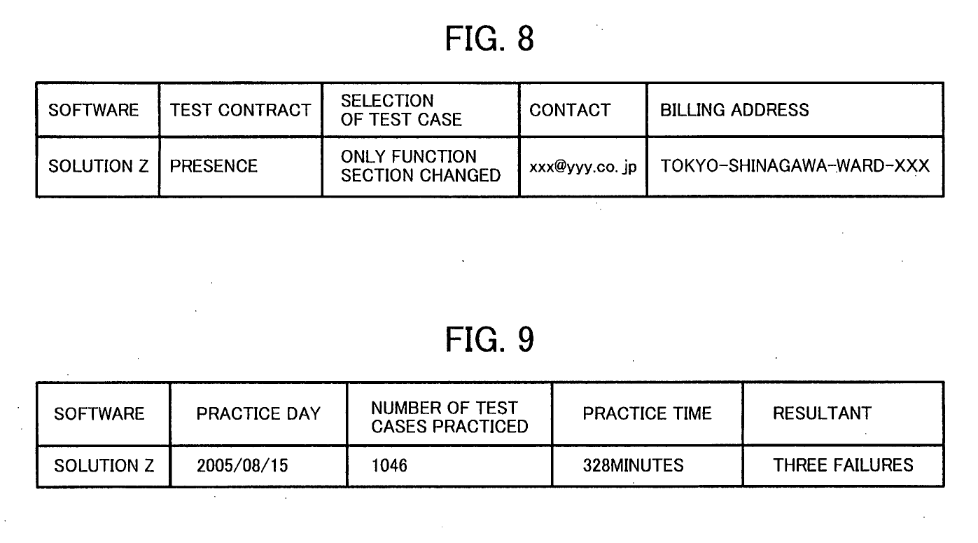

FIG. 8 illustrates setting information of software controlled by the program distribution server 3. Such information is used when it is determined if a test is executed.

FIG. 9 illustrates exemplary control information representing test execution result. The program distribution server 3 totals the information per test objective software. Based on information of FIG. 8, notification of the test result and the expense charge is forwarded.

Obviously, numerous additional modifications and variations of the present invention are possible in light of the above teachings. It is therefore to be understood that within the scope of the appended claims, the present invention may be practiced otherwise than as specifically described herein.

What is claimed is:

1. A program distribution server to distribute one of at least two software programs supplied from an external vender to a user terminal upon request, the program distribution server including:
first information related to at least two functions included in each of the at least two software programs supplied from the external vender;
second information specifying at least one of the at least two functions of the software, the at least one of the at least two functions being changed in accordance with upgrading of the at least two software programs;
third information indicating correspondence between the at least two software programs and dependent software installed in the user terminal, the depending software running in dependence upon one of the at least two software programs; and
fourth information indicating correspondence between the function of each of the at least two software programs and the dependent software, the function of each of the at least two software programs is used by the dependent software;
wherein the program distribution server determines a possibility of updating of software to be distributed to the user terminal based on the first, second, third and fourth information.

2. The program distribution server as claimed in claim 1, wherein the program distribution server notifies a developer terminal that an operational inspection for the dependence software is needed and
controls a test case execution device to executes a test case via LAN when the software is upgraded and determination if an operational inspection for dependence software is needed based on the first, second, third and fourth information is positive, the test case including operational inspection for dependence software;
and wherein program distribution server determines that the software can be updated when the test case is successful.

3. The program distribution server as claimed in claim 2, further comprising an accounting device to execute accounting while keeping security, wherein the program distribution server sends a bill for a testing cost to a test request terminal when the test case is executed.

4. A method of distributing program, comprising:
providing a program distribution server with first information representing at least two functions of software supplied from an external vender;
proving the program distribution server with second information specifying at least one function of the at least two functions changed in accordance with upgrading of the software;
proving the program distribution server with third information indicating correspondence between the software and dependent software installed in a user terminal, the dependent software running in dependence upon the software;
proving the program distribution server with fourth information indicating correspondence between each of the at least two functions and the dependent software;
receiving software from an external vender at the program distribution server;
determining a possibility of updating the software to be distributed to the user terminal based on the first, second, third and fourth information; and
distributing one of the at least two software programs to the user terminal from the program distribution server upon request in accordance with the possibility.

5. The method as claimed in claim 4, further comprising:
determining if an operational inspection for the dependent software is needed based on the first to fourth information when the software is upgraded;
notifying a developer terminal that an operational inspection is needed for the dependent software when the result of the determination is positive;
controlling a test case execution device to execute a test case via LAN, the test case including at least test program configured to test if the dependent software can operate in dependence upon the upgraded software; and
determining that the software can be updated when the test case is successful.

6. The method as claimed in claim 5 further comprising:
providing an accounting device for executing accounting while keeping security; and
sending a bill for a testing cost to a test request terminal when the test case is executed.

7. A program distribution program for controlling a computer to implement the program distribution method as claimed in any one of claims 4 to 6.

8. A recording medium recording program for executing the program distribution method as claimed in claim 7 when read by a computer.
